(19) United States
(12) Patent Application Publication
(10) Pub. No.: US 2026/0116557 A1
(43) Pub. Date: Apr. 30, 2026

(54) PROPULSION DEVICE AND A VTOL AIRCRAFT WITH A PROPULSION DEVICE

(71) Applicant: Rolls-Royce Deutschland Ltd & Co KG, Blankenfelde-Mahlow (DE)

(72) Inventors: Matthias MANIG, Doberlug-Kirchhaim (DE); Anton RUDENKO, Unterhaching (DE)

(21) Appl. No.: 18/441,176

(22) Filed: Feb. 23, 2024

(30) Foreign Application Priority Data
Feb. 15, 2023 (DE) 10 2023 103 681.5

(51) Int. Cl. B64D 27/40; B64C 29/00; B64D 27/30; B64D 33/08

(52) U.S. Cl. CPC B64D 27/40; B64C 29/0033; B64D 27/30; B64D 33/08

(57) ABSTRACT

The disclosure relates to a drive device having an electric drive, which is connected to an aircraft structure of a vertical take-off and landing (VTOL) aircraft, characterized by a strut device that connects the electric drive to the aircraft structure. The electric drive is configured to be pivotable relative to the aircraft structure about a pivot axis by a pivoting device, and at least one attachment device of the pivoting device is arranged on the aircraft structure.

The present patent document claims the benefit of German Patent Application No. 10 2023 103 681.5, filed Feb. 15, 2023, which is hereby incorporated by reference in its entirety.

### TECHNICAL FIELD

The disclosure relates to a drive device and to a vertical take-off and landing (VTOL) aircraft having such a drive or propulsion device.

### BACKGROUND

Aircraft that may take off and land vertically (VTOL: vertical take off and landing) are known in principle. If an electric drive is used as the drive device of such an aircraft, the latter is also designated as an eVTOL aircraft. Especially for the use of aircraft in the urban sector (UAM: urban air mobility), such aircraft are of considerable interest.

Different designs are used in principle, such as pure rotorcraft or designs with pivotable wings or pivotable drives.

In a design with pivotable drives, these are moved from a lift position into a forward drive position. The electric drives are connected to a wing via a drive device, with the pivoting taking place about an axis on or in the housing of the drive device.

### SUMMARY

The scope of the present disclosure is defined solely by the appended claims and is not affected to any degree by the statements within this summary. The present embodiments may obviate one or more of the drawbacks or limitations in the related art.

The object is to devise improved devices which in particular permit efficient cooling of the electric drives.

The object is achieved by a drive or propulsion device as disclosed herein.

A strut device is connected to an electric drive and to the aircraft structure. A strut is a component frequently running diagonally, which may predominantly absorb compressive and tensile forces. In particular, a strut device permits a weight-saving design, because forces may be absorbed specifically and in particular dissipated into the drive device.

The electric drive may be pivoted relative to the aircraft structure about a pivot axis by a pivoting device, wherein at least one attachment device of the pivoting device is arranged on the aircraft structure. The strut structure with the electric device may thus be moved by the pivoting from a position for forward flight into vertical flight (and vice versa).

For stable and efficient pivoting, the at least one attachment device is arranged above an axial, horizontal mid-plane of the drive device, i.e., pivoting is not carried out from the underside of the drive device.

The at least one attachment device may have an offset to the rear relative to the strut structure in the horizontal flight direction, the offset corresponding to at least a diameter of the strut structure. The offset has the effect of a spacing which permits pivoting of the strut structure without the latter colliding with the drive device.

The cooling of the electric drive is of particular importance so that, in one embodiment, at least one cooling air duct leads cooling air to the rear side of the electric drive. In addition, at least one electric inverter unit may be arranged on the strut device, in particular with a heat exchange surface to the at least one cooling air duct, which is connected to a cooling air inlet of the strut structure.

In one embodiment, the pivot axis for the at least one part of the strut device goes through two points of the aircraft structure. Additionally, or alternatively, the pivot axis may be located in the interior of the drive device, in particular in the axial, horizontal mid-plane of the drive device.

In one embodiment, the pivoting device may have a lever mechanism, (e.g., a hydraulically, electrically, or pneumatically driven lever mechanism).

In one embodiment, the pivoting device is connected to the strut structure via an articulated lever device. In this way, for example, the actuator may be removed from a load path that runs from the drive device via the strut device to the aircraft structure.

The electric drive device may be configured as a transverse flux machine or have a transverse flux machine.

### BRIEF DESCRIPTION OF THE DRAWINGS

The disclosure is explained in conjunction with the embodiments illustrated in the figures. In the figures:

FIG. 1 depicts a schematic illustration of a first embodiment of a first drive device in a side view.

FIG. 2 depicts a schematic illustration of the first embodiment in a plan view.

FIG. 3 depicts a schematic illustration of a second embodiment of the drive device in a view from the side.

FIG. 4 depicts a schematic illustration of the second embodiment according to FIG. 3 in a plan view.

FIG. 5 depicts a schematic illustration of a third embodiment of the drive device in a side view.

FIG. 6 depicts a schematic illustration of a fourth embodiment of the drive device in a side view.

FIG. 7 depicts a schematic illustration of a fifth embodiment of the drive device in a side view.

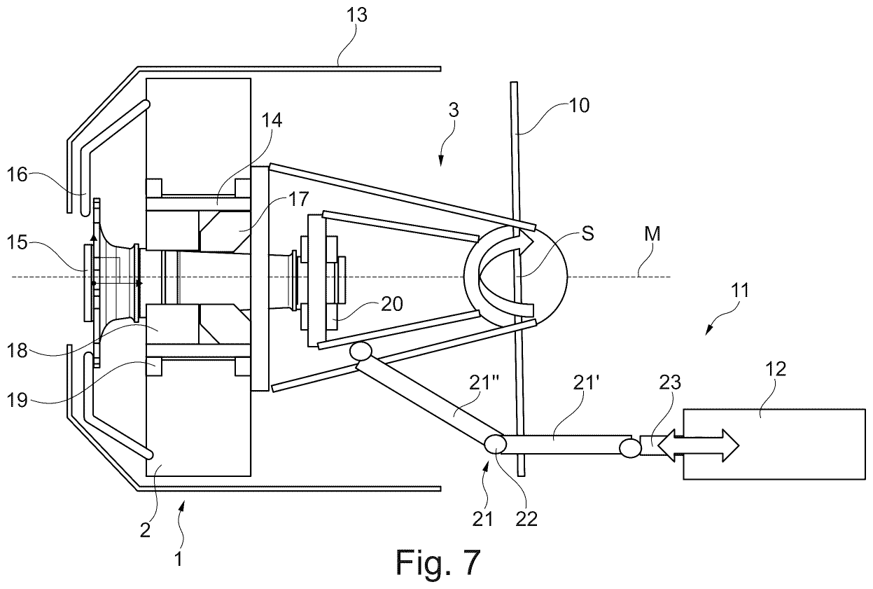

### DETAILED DESCRIPTION

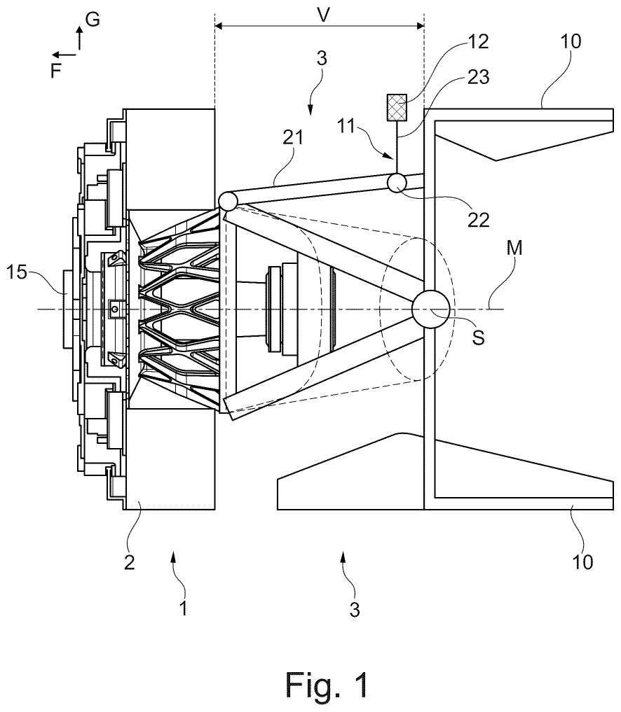

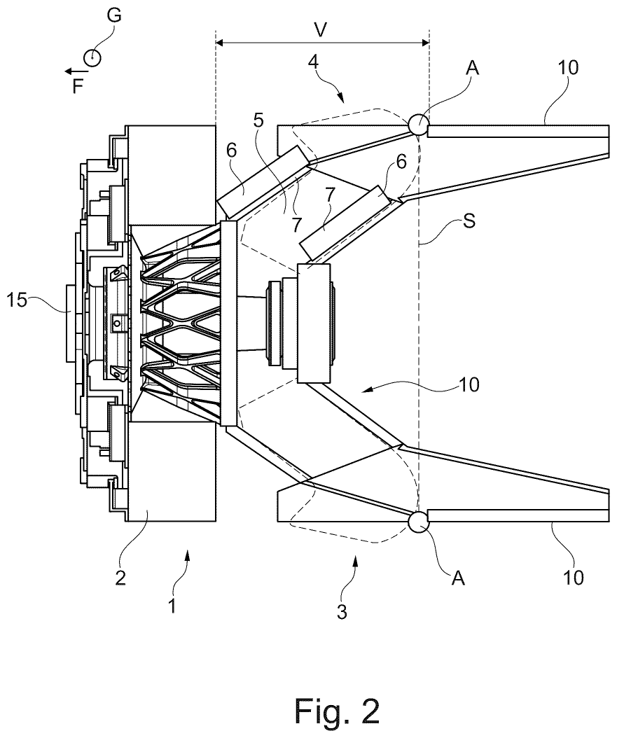

FIG. 1 and FIG. 2 each show in schematic illustrations a drive device 1 having an electric drive 2, which is coupled to an aircraft structure 10 via a strut structure 3. The aircraft structure 10 may be a fixed structure on or inside an aircraft part, the aircraft part not being illustrated here for reasons of clarity. The electric drive 2 drives a propeller, likewise not illustrated here, via a drive shaft 15.

The electric drive 2 is configured for a vertical take-off and landing aircraft, such as a UAM (urban air mobility) aircraft. The electric drive 2 may have a transverse flux machine.

In the illustrations of FIGS. 1 and 2, the strut structure 3 and the drive device 1 are arranged in front of the aircraft structure 10 as seen in the horizontal flight direction F.

The view of FIG. 1 is chosen such that the drive device 1 and the strut structure 3 are viewed from the side. The view of FIG. 2 shows a corresponding plan view, i.e., the drive device 1 is arranged on the left of the strut structure 3.

The drive device 1 is connected via the strut structure 3 and the aircraft structure 10 to a vertical take-off and landing aircraft, (e.g., via a wing). For reasons of clarity, the attachment to the vertical take-off and off and landing aircraft is not illustrated in FIGS. 1 and 2. In addition, walls which surround the drive device 1 and other components are not illustrated in FIGS. 1 and 2 for reasons of clarity.

In a vertical take-off and landing aircraft, the position of the drive device 1 may be changed relative to the aircraft structure 10, depending on the direction of flight. For the flight in the forward direction F (i.e., in the horizontal), the propeller is aligned in such a way that air is accelerated rearwards. This position is illustrated in FIGS. 1 and 2.

For the flight in the vertical direction G, the strut structure 3 together with the drive device 1 and the propeller is pivoted into the vertical direction G, so that the air is accelerated downwards.

In the illustration of FIG. 1, the drive device 1 is pivoted in the clockwise direction to the right. In the illustration in FIG. 2, such a pivoting action would lead out of the drawing plane.

FIG. 1 illustrates part of a pivoting device 11 with which the strut structure 3 may be pivoted relative to the aircraft structure 10 about a pivot axis S. In FIG. 2, the pivot axis S, which intersects the aircraft structure 10 at two points, is visible. In FIG. 1, the pivot axis S runs perpendicularly into the drawing plane.

Here, an actuator 12 (e.g., a hydraulic cylinder, an electric drive, or a pneumatic drive) is coupled via an adjustment element 23 to a lever arm of an articulated lever device 22, in order to adjust the strut structure 3 between the forward flight position F and the vertical flight position G.

The pivoting device 11 is connected to an attachment device A, (e.g., a fixed connection such as an attachment point), which is arranged on the aircraft structure 10.

In the schematic illustration of FIG. 1, the adjustment element 23 of the actuator 12 may execute a downward movement, so that as a result of the lever action the strut device 3 is pivoted in the clockwise direction, so that the strut structure 3 may be moved upwards into the vertical flight position G.

In the embodiment illustrated, the attachment device A has an offset V to the rear relative to the drive device 1 in the horizontal flight direction F. The offset V (measured from the front side of the strut structure 3) may correspond to at least the diameter of the strut structure 3 in order that the relative pivoting of the strut structure 3 is possible without the aircraft structure 10 being touched.

For efficient pivoting of the strut structure 3 between the flight directions F, G, the attachment device A is arranged above an axial, horizontal mid-plane M (see FIG. 1) of the drive device 1. Therefore, the movement of the strut structure 3 is effected from above and not from below.

In the embodiment illustrated, the pivot axis S is located in the interior, in particular in the axial, horizontal mid-plane M of the drive device 1 (see FIG. 2). In other embodiments, the pivot axis S may also be located above the axial, horizontal mid-plane M.

In a manner known per se, the strut structure 3 has inlet ports (not illustrated here) for cooling air, which is taken from the surroundings. In the illustration of FIG. 2, there are cooling air inlets 4 in each case at the side of the strut structure 3, from which cooling air ducts 5 are led into the interior of the strut structure 3. The cooling air is taken from the front in horizontal flight F through the inlet ports, not illustrated here, and then led to the rear side of the electric drive 2 via the curved cooling air ducts 5. The cooling of the electric drive 2 is of great importance for operational safety and service life.

One part of the electric drive 2 is electric inverter units 6, which likewise have to be cooled. For this purpose, these are arranged on the strut structure 3 in the vicinity of the cooling air ducts 5. It is also possible that the inverter units 6 have a heat exchange surface 7 to the cooling air ducts 5 (see FIG. 2).

Further embodiments, which are based on the principles illustrated previously, are illustrated below, so that in each case reference may be made to the above illustration.

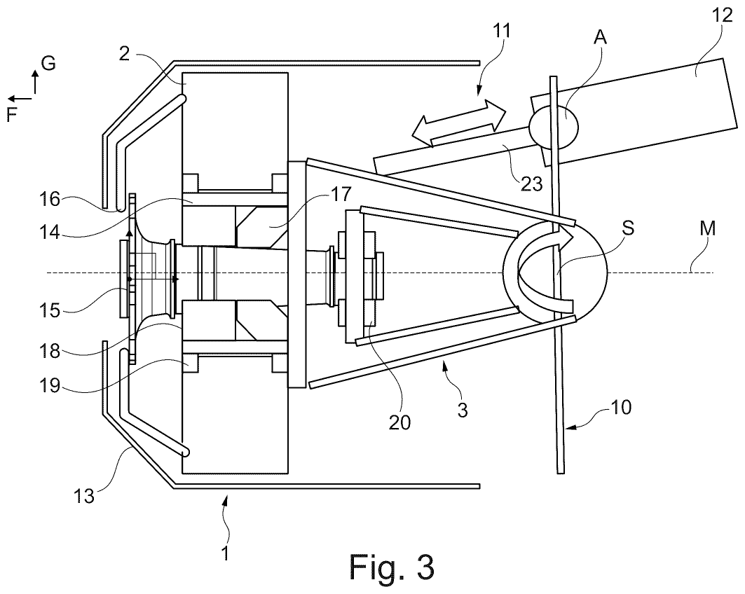

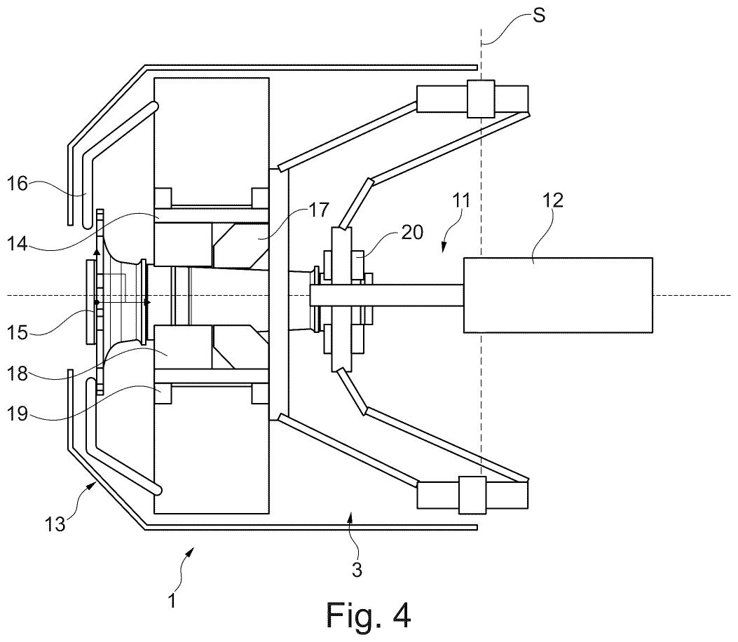

FIG. 3 shows a side view of the second embodiment of the drive device 1 with the strut structure 3 and the aircraft structure 10. FIG. 4 illustrates this embodiment in a plan view. Still further details are illustrated, primarily in connection with the drive unit 10.

Thus, here a pylon structure 13 is illustrated, which is part of the drive structure 1 and in particular surrounds the electric drive 2 and to some extent also the strut structure 3. The electric drive 2 is arranged here around the axis of rotation of the drive shaft 15 for the propeller, not illustrated here, a motor structure 14 connecting the static part of the electric drive 2 to the remainder of the drive device 1 and the strut structure 3.

The rotatable, radially outer part of the electric drive 2 is connected via a connecting device 16 to the drive shaft 15, which may thus be set rotating.

The drive shaft 15 is supported axially at the front relative to the static parts of the drive device 1 via a first bearing device 18, a supporting structure 17 fixing the first bearing device 18 axially with respect to non-rotating parts.

The rotating part of the electric drive 2 is supported relative to the motor structure 14 via a second bearing device 19.

The drive shaft 15 is supported axially at the rear relative to the strut structure 3 via a third bearing device 20.

To pivot the electric drive 2, the latter is coupled to the actuator 12 via the strut structure 3 (see FIG. 3). Here, the actuator 12 is pivotably connected to the aircraft structure 10 via an attachment device A but is otherwise fixedly connected. The movable part of the actuator 12, the adjustment element 23, is connected to the strut structure 3. The strut structure 3 (as in the first embodiment) is rotatably connected to the fixed aircraft structure 10.

If the adjustment element 23 is retracted linearly to the right, the strut structure 3 is rotated in the clockwise direction about the pivot axis S, i.e., the electric drive 2 with the drive shaft 15 is pivoted into the vertical. In the illustration of FIG. 4, this pivoting corresponds to pivoting out of the drawing plane.

If the actuator 12 is extended linearly to the left, the strut structure 3 is rotated in the anti-clockwise direction about the pivot axis S, i.e., the electric drive 2 with the drive shaft 15 is pivoted into the horizontal. In the illustration of FIG. 4, this pivoting corresponds to pivoting into the drawing plane.

In the illustration of FIG. 4, the attachment device A and the actuator 12 are arranged in the plane of the axis of rotation of the drive shaft 15, i.e., they are arranged centrally on the aircraft structure 10.

In principle, it will be best to minimize the forces on the actuator 12 and the pivoting device 11 in the vertical position. Here, the pivot axis S is arranged in the axial mid-plane M (see FIG. 3). However, it may also be arranged over or under the same. It is also possible that the attachment device A may be arranged to be displaced laterally (in the sense of FIG. 4).

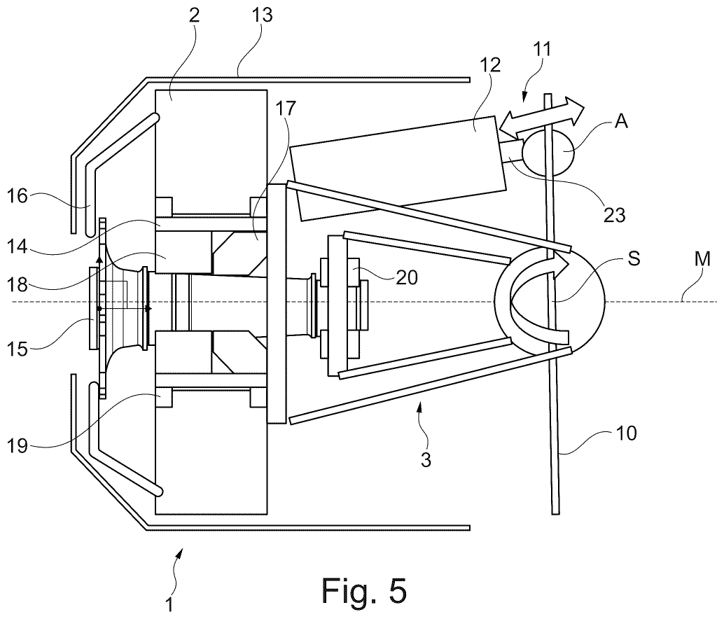

In FIG. 5, a variant of the second embodiment is illustrated as a third embodiment, a side view being illustrated here, analogous to FIG. 3. The function of the third embodiment corresponds to that of the second, so that reference may be made to the corresponding description.

However, the mode of action of the actuator 12 is inverted, i.e., the pivoting device 11 is coupled to the attachment device A on the aircraft structure 10. On the other hand, the actuator 12 is coupled to the strut device 3. Retracting the adjustment element 23 away from the aircraft structure 10 results in pivoting upwards in the clockwise direction. In addition to the mechanical loads of the adjustment, the actuator 12 here also absorbs loads from the flight operation (aerodynamic loads).

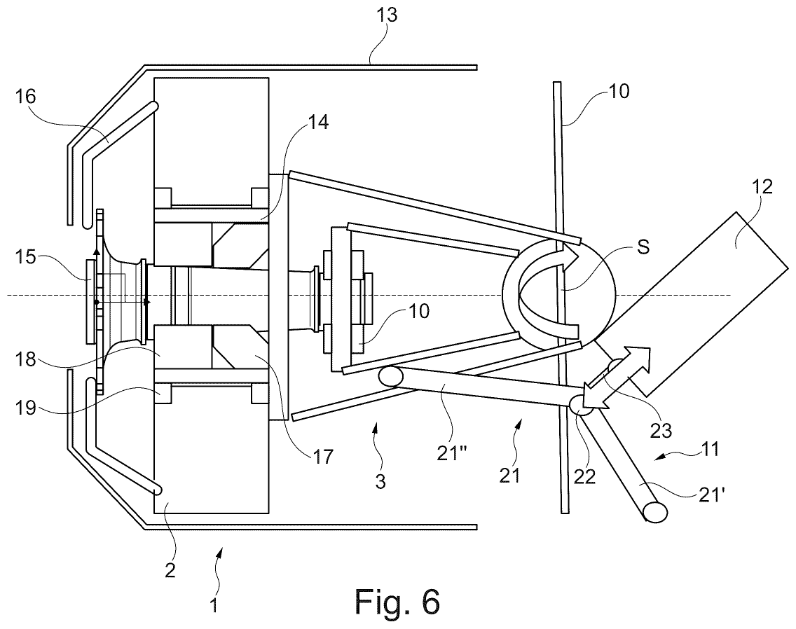

In FIG. 6, a fourth embodiment, which differs from the previously described embodiments in the arrangement and design of the pivoting device 11 and of the actuator 12, is illustrated.

Here, actuator 12 and pivoting device 11 act on the strut structure 3 via an articulated lever device 21.

In the embodiment illustrated, the articulated lever structure 21 has two lever elements. The first lever element 21′is connected pivotably but otherwise firmly to the aircraft structure 10. The second lever element 21″ is connected pivotably but firmly to the strut structure 3. The adjustment element 23 of the actuator 12 acts on the connecting joint 22 of the two lever elements 21′, 21″.

In this design, the actuator 12 may be arranged further in the interior (here axially further behind), wherein the physical arrangement may be configured more flexibly as a result of the interposition of the articulated lever structure 21 in order, for example, to take physical restrictions into account.

If, in the embodiment illustrated, the adjustment element 23 is moved in the direction away from the actuator 12, then the point of action on the connecting joint 22 is forced downwards, so that the angle between the lever elements 21′, 21″ is enlarged. As a result, the strut structure 3 begins to pivot in the clockwise direction, so that the electric drive is moved into the vertical.

Conversely, retraction of the adjustment element 23 out of the actuator 12 leads to pivoting in the opposite direction.

The articulated lever structure 21 here has the advantage that the actuator 12 and the pivoting device 11 are not located directly in the load path, because the flight loads are transmitted to the static aircraft structure 10 via the articulated lever structure 21.

The fifth embodiment, which is illustrated in FIG. 6, represents a modification of the fourth embodiment. Here, too, the drive device 1 is pivoted via an articulated lever structure 21 having two articulated lever elements 21′, 21″. However, the adjustment element 23 of the actuator 12 does not act on the connecting joint 22 but on that end of the articulated lever structure 21 which is located axially at the rear. The actuator 12 is aligned such that the adjustment element 23 may effect only a movement in the axial direction (forwards-rearwards). The articulated lever elements 21′, 21″ are guided on the aircraft structure 10.

Here, the actuator 12 is firmly connected to the aircraft structure 10. If the adjustment element 23 is pushed axially forwards, then the strut structure 3 is tilted in the clockwise direction about the pivot axis S, i.e., into the vertical. A movement of the pivoting device 23 axially rearwards leads to an opposite movement of rotation.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

### LIST OF REFERENCE SYMBOLS

1 Drive device
2 Pivotable electric drive
3 Strut structure
4 Cooling air inlet
5 Cooling air duct
6 Inverter unit
7 Heat exchange surface
10 Aircraft structure
11 Pivoting device
12 Actuator
13 Pylon structure
14 Motor structure
15 Drive shaft for propeller
16 Electric drive-drive shaft connecting device
17 Support structure
18 First bearing device
19 Second bearing device
20 Third bearing device
21 Articulated lever device
21′ First lever element
21″ Second lever element
22 Connecting joint
23 Adjustment element
A Attachment device of the pivoting device
F Horizontal flight direction
G Vertical flight direction
M Axial mid-plane
S Pivot axis of the electric drive
V Offset of the attachment device in the horizontal direction

1. A drive device comprising:
an electric drive; and
a strut device configured to connect the electric drive to an aircraft structure of a vertical take-off and landing (VTOL) aircraft,
wherein the electric drive is configured to be pivotable relative to the aircraft structure about a pivot axis by a pivoting device, and
wherein at least one attachment device of the pivoting device is arranged on the aircraft structure.

2. The drive device of claim 1, wherein the at least one attachment device is arranged above an axial, horizontal mid-plane of the drive device.

3. The drive device of claim 1, wherein the at least one attachment device has an offset to a rear relative to the electric drive in a horizontal flight direction, and
wherein the offset corresponds to at least a diameter of the strut device.

4. The drive device of claim 1, wherein at least one cooling air duct is configured to lead cooling air to a rear side of the electric drive.

5. The drive device of claim 4, wherein at least one electric inverter unit is arranged on the strut device with a heat exchange surface to the at least one cooling air duct.

6. The drive device of claim 1, wherein the pivot axis for at least one part of the strut device is configured to be positioned through two points of the aircraft structure.

7. The drive device of claim 1, wherein the pivot axis is configured to be located in an interior of an aircraft part.

8. The drive device of claim 1, wherein the strut device is coupled to an actuator of the pivoting device.

9. The drive device of claim 1, wherein the pivoting device is connected to the strut device via an articulated lever device.

10. The drive device of claim 1, wherein the strut device is configured to be pivotable by the pivoting device between a position for a horizontal flight direction and a position for a vertical flight direction.

11. The drive device of claim 1, wherein the electric drive comprises a transverse flux machine.

12. A vertical take-off and landing (VTOL) aircraft comprising:
at least one drive device having:
an electric drive; and
a strut device connecting the electric drive to an aircraft structure of the VTOL aircraft,
wherein the electric drive is configured to be pivotable relative to the aircraft structure about a pivot axis by a pivoting device, and
wherein at least one attachment device of the pivoting device is arranged on the aircraft structure.

13. The drive device of claim 7, wherein the pivot axis is configured to be located in an axial, horizontal mid-plane of the drive device.

14. The drive device of claim 1, wherein at least one electric inverter unit is arranged on the strut device.

15. The drive device of claim 8, wherein the actuator is a hydraulic actuator, an electric actuator, or a pneumatic actuator.
